(19) United States
(12) Patent Application Publication
(10) Pub. No.: US 2006/0112271 A1
(43) Pub. Date: May 25, 2006

(54) Cipher mail server device

(75) Inventors: Kazuo Soumiya, Kyoto-shi (JP); Shigeki Takeuchi, Otsu-shi (JP); Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/254,324

(22) Filed: Oct. 20, 2005

(30) Foreign Application Priority Data
Nov. 22, 2004 (JP) 2004-337367
Nov. 22, 2004 (JP) 2004-337368
Jan. 25, 2005 (JP) 2005-016610

(51) Int. Cl. H04L 9/00

(52) U.S. Cl. 713/168

(57) ABSTRACT

A cipher mail server device includes a mail receiving unit, a management table, a determination unit and a processing unit. The mail receiving unit receives mail. The management table stores mail processing information indicating a processing content of mail for each account by associating with each account. The determination unit accesses to the management table when the mail receiving unit receives the mail, acquires the mail processing information associated with an account of a destination of the mail, and determines a processing content for the mail. The processing unit executes the processing content determined by the determination unit on the mail.

### BACKGROUND OF THE INVENTION

1. Field of the Invention

The present invention relates to a cipher mail server device, and in particular, relates to a cipher macil server device, which executes processing such as encryption, decryption, signature and verification on electronic mail.

2. Description of the Related Art

A proposal has been made to encrypt electronic mail (hereinafter “mail”) for preventing the mail from being read by a third party, and to add an electronic signature to mail for confirming that the mail has been transmitted by a true transmitter and that the mail has not been falsified during transmission.

### SUMMARY OF THE INVENTION

An advantage of the present invention is to provide a cipher mail server device, which can set for each account, a function for executing a prescribed processing on mail, for example, whether or not to encrypt or decrypt the mail, or whether or not to add or verify an electronic signature.

Another advantage of the present invention is to enable a signature to be added to mail even when a client has not acquired a unique certificate.

Another advantage of the present invention is to eliminate necessity of encrypting and decrypting mail at a client and to enable the client to confirm that received mail has been transmitted safely through encrypted communication.

According to an aspect of the present invention, a cipher mail server device includes a receiving unit, a management table, a determination unit, a processing unit and a transfer unit. The receiving unit receives mail. The management table stores mail processing information indicating a processing content of the mail for each account by associating with each account. When the receiving unit receives the mail, the determination unit accesses to the management table, acquires the mail processing information associated with an account of the mail, and determines the processing content for the mail. The processing unit executes the processing content determined by the determination unit on the mail. The transfer unit transfers the mail executed with the processing content.

That is, a processing content of received mail can be designated for each account. For example, the cipher mail server device can designate for each account, whether or not to execute a function of encrypting received mail, adding an electronic signature, decrypting encrypted mail or verifying mail with a signature. As a result, a handling of mail can be set flexibly, and convenience improves.

According to another aspect of the present invention, a cipher mail server device includes a receiving unit, an electronic signature unit, a storage unit and a control unit. The receiving unit receives mail. The electronic signature unit adds an electronic signature to mail. The storage unit stores a certificate shared by a plurality of clients and a certificate unique to a client. When mail received from a client does not have a certificate unique to the client, the control unit adds an electronic signature by the electronic signature unit based on the shared certificate stored in the storage unit. That is, with respect to the electronic signature, the storage unit stores a certificate shared by clients and a certificate unique to a client, and the electronic signature unit adds an electronic signature based on the shared certificate to mail received from a client not having a unique certificate.

According to another aspect of the present invention, a cipher mail server device includes a receiving unit, a decryption unit, an adding unit and a transfer unit. The receiving unit receives mail. When the mail received from another mail server is encrypted, the decryption unit decrypts the mail. The adding unit adds a comment indicating that the received mail was encrypted to the decrypted mail. The transfer unit transfers the mail added with the comment to a client.

When an electronic signature of mail is verified, the transfer unit preferably transfers the mail to a client after adding a verification result as a comment.

Further, any combinations of the above-described constituent elements and the conversions of the expression of the present invention between a method, a device, a system, a recording medium, a computer program or the like are also effective as an embodiment of the-present invention.

According to the above-described aspect, the cipher mail server device can set the handling of the received mail flexibly and is highly convenient.

Even when a client does not have a unique certificate, the client can add an electronic signature based on a shared certificate.

The cipher mail server device decrypts and verifies received encrypted mail. As a result, a client is not required to carry out a decryption and a verification. Moreover, a comment indicating a fact that mail has been received in a form of an encrypted text and with an electronic signature is added to the received mail, and the received mail is transferred to a client. As a result, the client can confirm that the received mail has been transmitted safely.

### BRIEF DESCRIPTION OF THE DRAWINGS

FIG. 1 is a functional block diagram illustrating a configuration of a cipher mail server device according to a first embodiment of the present invention.

FIG. 2 is a functional block diagram illustrating a configuration for setting a management table of the cipher mail server device of FIG. 1.

FIG. 3 is a functional block diagram illustrating a configuration for recording a processing result of the cipher mail server device of FIG. 1.

FIG. 4 illustrates an example of an insertion document generated by a recording unit of the cipher mail server device of FIG. 3.

FIG. 5 illustrates an example of a configuration of the management table of FIG. 1.

FIG. 6 is a flowchart illustrating an example of an operation of the cipher mail server device of FIG. 1.

FIG. 7 is a block diagram illustrating a configuration of a mail server and a system configuration using the mail server according to a second embodiment of the present invention.

FIG. 8 schematically illustrates a certificate database used in the second embodiment of the present invention.

FIG. 9 schematically illustrates a client database used in the second embodiment of the present invention.

FIG. 10 schematically illustrates a destination database used in the second embodiment of the present invention.

FIG. 11 is a flowchart illustrating an algorithm at transmission according to the second embodiment of the present invention.

FIG. 12 is a block diagram illustrating a configuration of a mail server and a system configuration using the mail server according to a third embodiment of the present invention.

FIG. 13 schematically illustrates a certificate database used in the third embodiment of the present invention.

FIG. 14 schematically illustrates a client database used in the third embodiment of the present invention.

FIG. 15 schematically illustrates a destination database used in the third embodiment of the present invention.

FIG. 16 schematically illustrates a certificate of a certificate authority.

FIG. 17 is a flowchart illustrating an algorithm at reception according to the third embodiment of the present invention.

FIG. 18 schematically illustrates a transmission process from an Internet facsimile machine to an Internet facsimile machine according to the third embodiment of the present invention.

FIG. 19 is a flowchart illustrating an algorithm at reception according to another example of the third embodiment of the present invention.

FIG. 20 is a flowchart illustrating an algorithm, which is a continuation of FIG. 19.

### DETAILED DESCRIPTION OF PREFERRED EMBODIMENTS

(First Embodiment) With reference to the drawings, a description will be made of a first embodiment of the present invention. In all of the drawings, like reference numerals represent like constituent elements, and a description is omitted as appropriate.

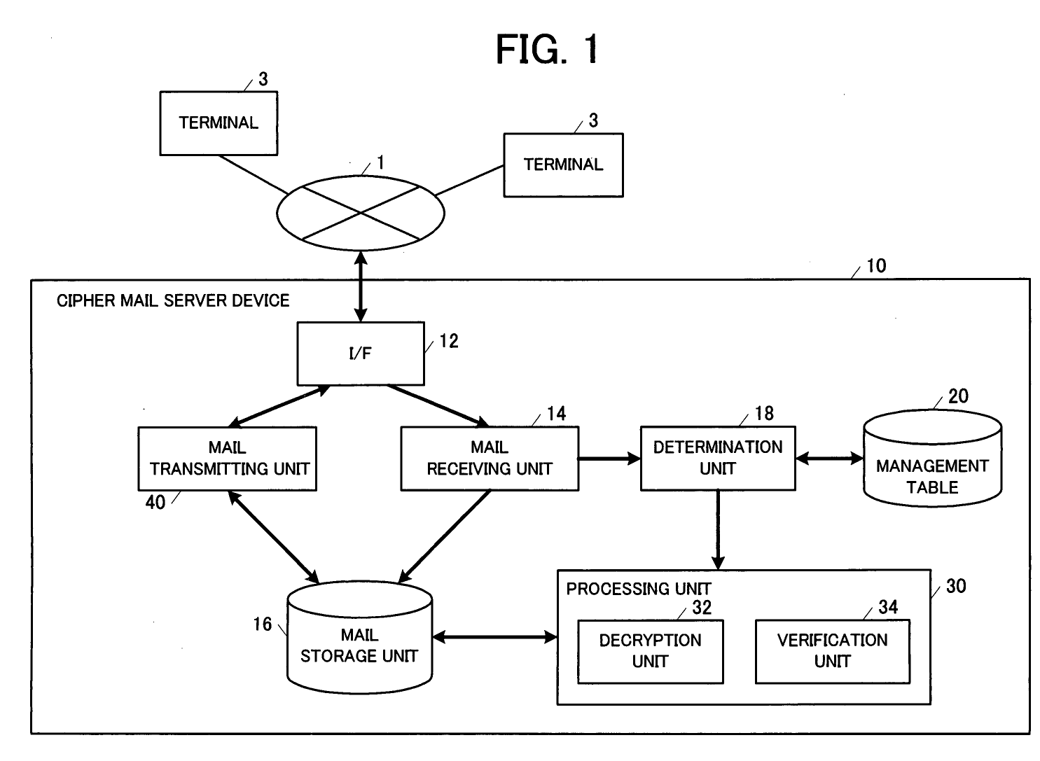

FIG. 1 is a functional block diagram illustrating a cipher mail server device according to a first embodiment of the present invention. A cipher mail server device 10 of the first embodiment includes a receiving unit (an interface unit 12 and a mail receiving unit 14), a management table (a management table 20), a determination unit (a determination unit 18) and a processing unit (a processing unit 30). The receiving unit receives mail. The management table stores mail processing information indicating a processing content of mail for each account by associating with each account. When the receiving unit receives the mail, the determination unit accesses to the management table, acquires the mail processing information associated with an account of a destination of the received mail, and determines the processing content for the received mail. The processing unit executes the processing content determined by the determination unit on the received mail.

For example, the cipher mail server device 10 is connected to a network 1 such as a Local Area Network (LAN) and the Internet. The cipher mail server device 10 receives mail from a plurality of terminals 3 connected to the network 1. In addition, according to a mail reception request from a terminal 3, the cipher mail server device 10 distributes mail. Alternatively, the cipher mail server device 10 may be included in an extension board connected via the network 1 to a main body of a network scanner, an Internet facsimile machine, a Multi Function Peripheral (MFP) or the like. Further, in FIG. 1, a configuration of a part unrelated to the subject matter of the present invention is omitted.

Each of the constituent elements of the cipher mail server device 10 is realized by any combination of hardware and software primarily by a Central Processing Unit (CPU) of any computer, a memory, a program which realizes the constituent elements shown in FIG. 1 loaded to the memory, a storage unit such as a hard disk drive which stores the program, and an interface for establishing a connection with a network. It is understood by those skilled in the art that various changes and modifications can be made for methods and devices for realizing each of the constituent elements of the cipher mail server device 10. Each of the drawings to be described hereinafter shows blocks representing units of function, instead of units of hardware.

As illustrated in FIG. 1, the cipher mail server device 10 includes the interface unit 12 (in the drawing, “I/F”), the mail receiving unit 14, a mail storage unit 16, the determination unit 18, the management table 20, the processing unit 30 and a mail transmitting unit 40.

The interface unit 12 carries out communication with the plurality of the terminals 3 via the network 1. The mail receiving unit 14 receives mail from the terminals 3 via the network 1. The mail storage unit 16 stores the mail received by the mail receiving unit 14 for each account of a destination of the received mail. The management table 20 stores mail processing information indicating a processing content of the mail for each account by associating with each account. Details will be described later.

When the mail receiving unit 14 receives the mail, the determination unit 18 accesses the management table 20, acquires mail processing information associated with an account of a destination of the mail, and determines a processing content for the mail.

The processing unit 30 includes a decrypting unit 32 and a verification unit 34. The decryption unit 32 decrypts received encrypted mail. The verification unit 34 carries out a path verification of a signature of the received mail with the signature. According to a request from a terminal 3 on the network 1, the mail transmitting unit 40 transmits the received mail stored in the mail storage unit 16 to the corresponding terminal 3 via the interface unit 12.

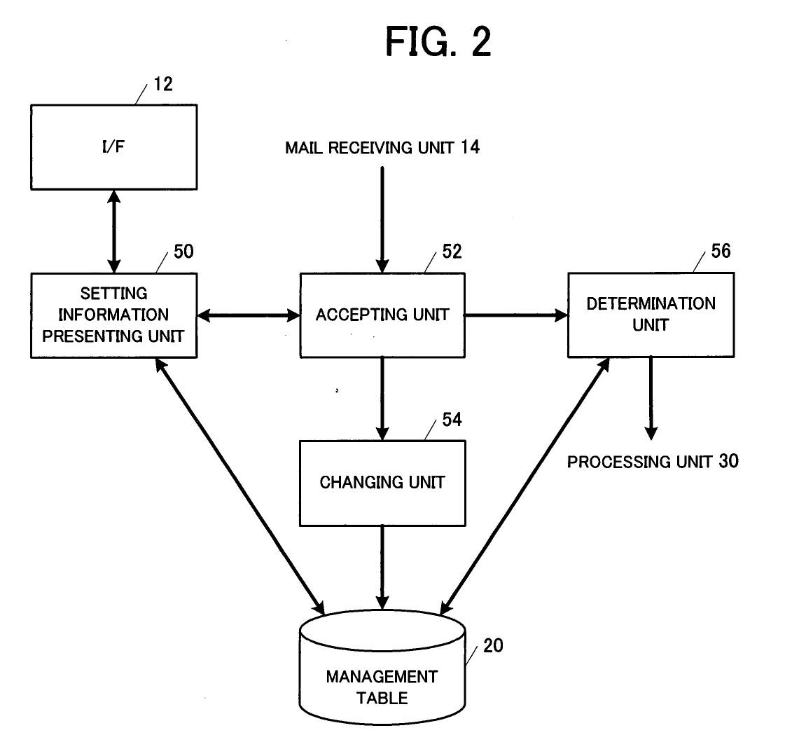

FIG. 2 is a functional block diagram illustrating a configuration for carrying out a setting of the management table 20 of the cipher mail server device 10 according to the first embodiment. The cipher mail server device 10 includes a setting information presenting unit 50, an accepting unit 52, a changing unit 54 and a determination unit 56.

The setting information presenting unit 50 presents mail processing information included in the management table 20 to the terminal 3 on the network 1 via the interface unit 12. For example, the terminal 3 can access the cipher mail server device 10 by using a web browser (not shown) or the like, and display a setting screen (not shown) presented by the setting information presenting unit 50 on a display unit (not shown) of the terminal 3. The setting information presenting unit 50 acquires the mail processing information associated with the account requested by the terminal 3 from the management table 20, and displays the acquired mail processing information on the setting screen. Here, the terminal 3 is permitted to access the management table 20, for example, by entering a previously registered password and logging into the cipher mail server device 10.

The accepting unit 52 accepts a changing instruction for changing the mail processing information set in the management table 20 from the terminal 3 on the network 1 via the interface unit 12 and the setting information presenting unit 50. Alternatively, the accepting unit 52 can accept a changing instruction for changing the mail processing information set in the management table 20 by receiving mail described under a prescribed format by the mail receiving unit 14. Alternatively, the accepting unit 52 can accept a setting changed by a manager of the cipher mail server device 10 operating an operation unit (not shown) from the setting screen presented by the setting information presenting unit 50.

The changing unit 54 changes the mail processing information set in the management table 20 in accordance with the changing instruction accepted by the accepting unit 52. Further, in the first embodiment, when the setting of the management table 20 is changed, a setting can be made as to whether or not to reflect the changed setting on the received mail already stored in the mail storage unit 16. That is, for example, when a setting for not decrypting encrypted mail is changed to a setting for decrypting the encrypted mail, a setting can be made as to whether to reflect the change on the received mail already stored in the storage unit 16. Therefore, when the setting is set to reflect the change, the decryption unit 32 of the processing unit 30 decrypts the received mail already stored in the mail storage unit 16.

The determination unit 56 determines whether or not the setting is set to reflect the change on the already received mail. When the setting is set to reflect the change, after a change is made to the setting, the determination unit 56 instructs the processing unit 30 to execute each processing on the already received mail stored in the mail storage unit 16.

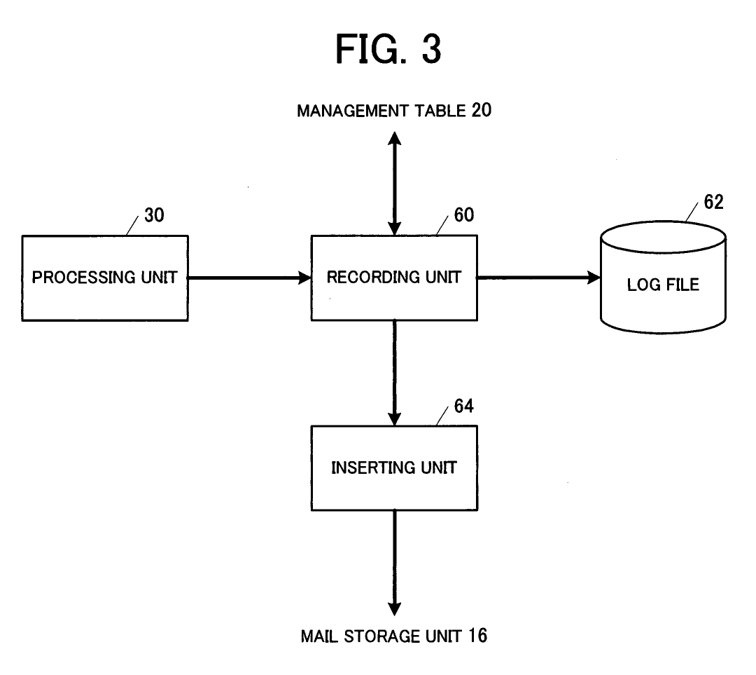

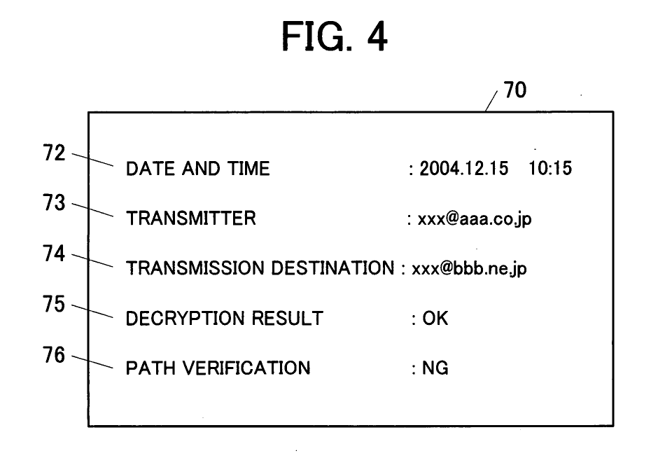

FIG. 3 is a functional block diagram illustrating a configuration for recording a processing result of the cipher mail server device 10 according to the first embodiment. The cipher mail server device 10 includes a recording unit 60, a log file storage unit 62 (in the drawing, “log file”) and an inserting unit 64. The recording unit 60 records a history of a processing at the processing unit 30 in a form of an insertion document to mail or a log file. As illustrated in FIG. 4, an insertion document 70 can include a date and time 72 of a decryption processing, a transmitter account 73, a transmission destination account 74, a decryption result 75 and a path verification result 76 or the like of the received mail.

The log file storage unit 62 stores a log file recorded by the recording unit 60. The log file is recorded for each account. The manager can refer to the log file via the operation unit of the cipher mail server device 10. Alternatively, the manager can refer to the log file by using a web browser or the like from each terminal 3 on the network 1 via the interface unit 12.

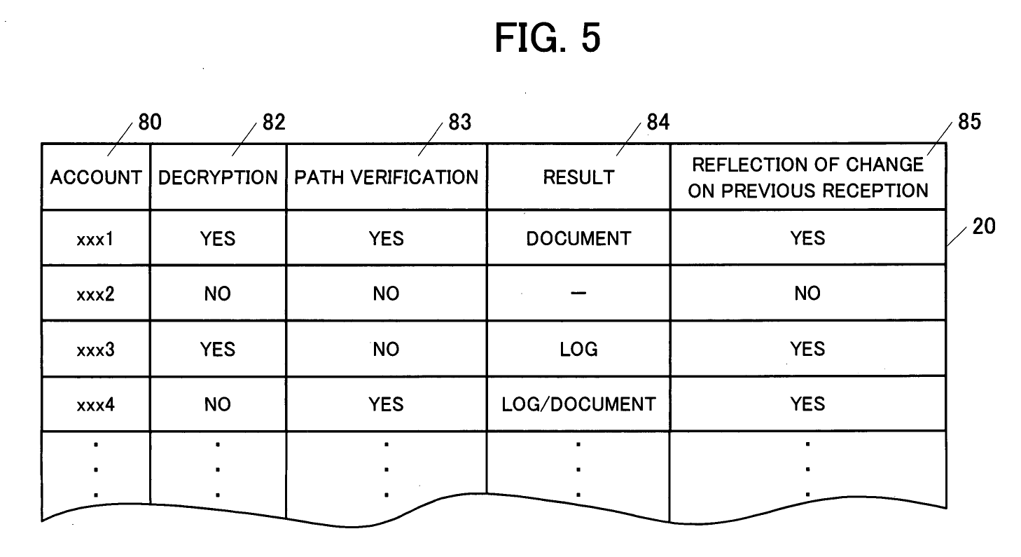

FIG. 5 illustrates an example of a configuration of the management table 20 according to the first embodiment. The management table 20 includes a decryption setting 82 (in FIG. 5, “decryption”), a path verification setting 83 (in FIG. 5, “path verification”), a result setting 84 (in FIG. 5, “result”) and a change reflection setting 85 (in FIG. 5, “reflection of change on previous reception”) for each account 80. The decrypting setting 82 is a setting of whether or not to execute a decryption processing. The path verification setting 83 is a setting of whether or not to execute a path verification. The result setting 84 is a setting of whether to record the result of the decryption processing and the path verification in a form of an insertion document or in a log file. The change reflection setting 85 is a setting of whether or not to reflect a change on a previous reception.

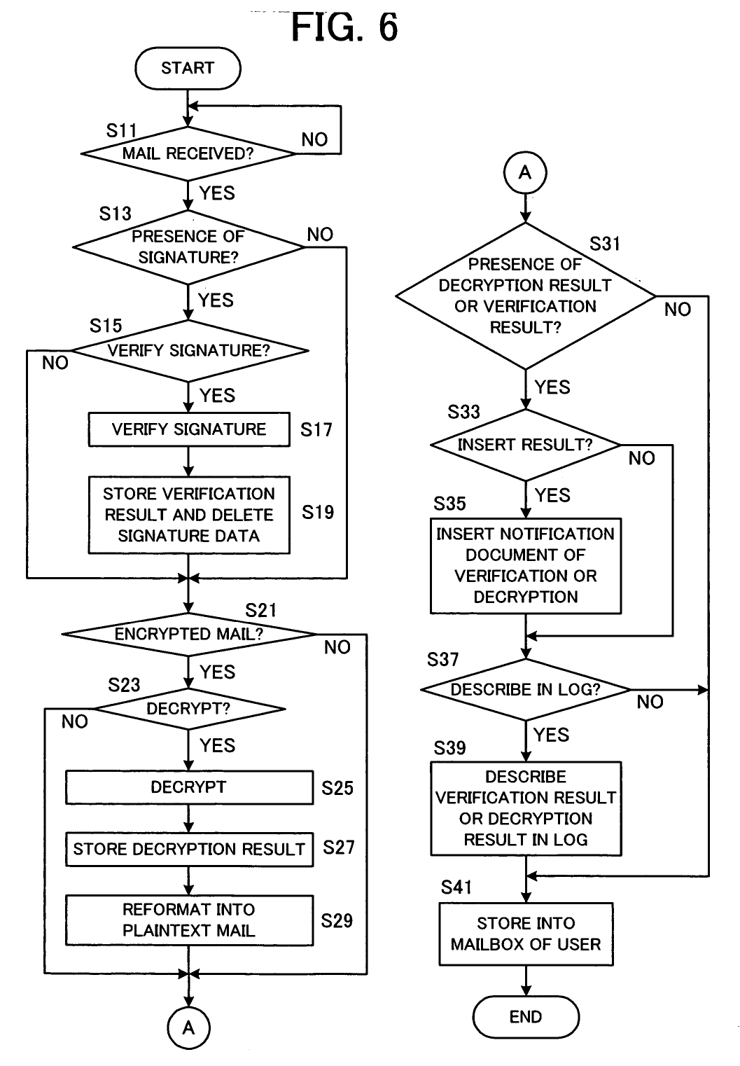

Next, a description will be made of an operation of the cipher mail server device 10 according to the first embodiment. FIG. 6 is a flowchart illustrating an example of an operation of the cipher mail server device 10 according to the first embodiment. In the following, a description will be made with reference to FIG. 1 through FIG. 6.

First, in the cipher mail server device 10, the mail receiving unit 14 monitors a reception of mail from the terminal 3 on the network 1 via the interface unit 12 (step S11). When the mail receiving unit 14 receives mail (step S11: YES), the determination unit 18 determines whether or not the received mail is mail with a signature (step S13). When the received mail is mail with a signature (step S13: YES), the determination unit 18 accesses the management table 20, and refers to the path verification setting 83 of the account 80 of a destination of the received mail for determining whether or not to carry out a path verification. When the path verification setting 83 is a setting for carry out the path verification (step S15: YES), the verification unit 34 carries out the path verification on the signature of the received mail (step S17). Then, a result of the path verification at step S17 is stored temporarily in a temporary storage unit (not shown), and the verification unit 34 deletes the signature data from the received mail (step S19).

When a signature is not attached to the received mail (step S13: NO), or when the path verification setting 83 is a setting for not carrying out the path verification (step S15: NO), the processes of step S17 and step S19 are bypassed, and the process proceeds onto step S21.

At step S21, the determination unit 18 determines whether or not the received mail is encrypted mail. When the received mail is encrypted mail (step S21: YES), the determination unit 18 accesses to the management table 20, and refers to the decryption setting 82 of the account 80 of the destination of the received mail for determining whether or not to execute a decryption processing. When the decryption setting 82 is a setting for carrying out the decryption processing (step S23: YES), the decryption unit 32 decrypts the received mail (step S25). A decryption result of step S25 is stored temporarily in the temporary storage unit (step S27). Next, the decryption unit 32 reformats the mail into plaintext mail and stores into the mail storage unit 16 (step S29).

When the received mail is not encrypted mail (step S21: NO), or when the decryption setting 82 is a setting for not carrying out a decryption processing (step S23: NO), the processes of step S25 through step S29 are bypassed, and the process proceeds onto step S31.

At step S31, the recording unit 60 determines a presence or an absence of the decryption result or the verification result stored in the temporary storage unit at step S19 or step S27. In case of a presence of the result (step S31: YES), the recording unit 60 accesses the management table 20, and determines whether or not the result setting 84 is an insertion document (step S33). When the result setting 84 includes an insertion document (step S33: YES), the recording unit 60 generates the insertion document 70 including the result. Then, the inserting unit 64 inserts the insertion document 70 into the mail (step S35). When the result setting 84 does not include an insertion document (step S33: NO), the process proceeds onto step S37.

Next, the recording unit 60 accesses the management table 20, and determines whether or not the result setting 84 is a log (step S37). When the result setting 84 includes a log (step S37: YES), the recording unit 60 records the result into a log file and stores into the log file storage unit 62 (step S39). When the result setting 84 does not include a log (step S37: NO), the process proceeds onto step S41. In case of an absence of a decryption result or a verification result (step S31: NO), the process also proceeds onto step S41.

At step S41, the received mail executed with the above-described processes is stored into the mail storage unit 16 for each account. As described above, the received mail can be processed in accordance with the processing content set in the management table 20.

Next, with reference to FIG. 1 through FIG. 5, a description will be made of an operation when a setting of the management table 20 has been changed.

The accepting unit 52 accepts an instruction for changing the decryption setting 82 from “NO” to “YES” for a certain account 80 (xxx1) in the management table 20 of FIG. 5. In accordance with a change content accepted by the accepting unit 52, the changing unit 54 changes the decryption setting 82 of the corresponding account 80 (xxx1) in the management table 20. Meanwhile, after the accepting unit 52 accepts the instruction for changing, the determination unit 56 accesses the management table 20, refers to the setting of the change reflection setting 85, and determines whether or not to reflect the change. In this example, the change reflection setting 85 is set “YES”. Therefore, the determination unit 56 instructs the processing unit 3 to carry out a decryption processing of the encrypted mail for the received mail already stored in the mail storage unit 16.

The recording unit 60 accesses the management table 20. Since the result setting 84 is set to “document”, the recording unit 60 generates a decryption result as the insertion document 70. Then, the inserting unit 64 inserts the insertion document 70 into the corresponding mail and stores it in the mail storage unit 16. As described above, according to necessity, a processing can be executed also on the mail already received prior to the acceptance of the changing instruction. As a result, convenience improves.

As described above, according to the cipher mail server device 10 of the first embodiment, the setting of the processing content of the received mail can be stored in the management table 20 by associating with each account, and the processing of the received mail can be carried out in accordance with the management table 20. As a result, a handling of the received mail can be set flexibly and convenience improves.

For each account, a setting can be made as to whether or not to decrypt received encrypted mail by the cipher mail server device 10 and whether or not to carry out a path verification on received mail with a signature. Therefore, a setting can be made according to a convenience of a client, and convenience improves. For example, a setting can be made to store the encrypted mail as it is without decrypting when a client is absent over a long period of time. As a result, even when a client is absent over a long period of time, mail is not left over a long period of time on a server under a state in which the mail is decrypted. Thus, security also improves.

The first embodiment of the present invention has been described with reference to the drawings. However, the above-described embodiment is just an example of the present invention. Various other configurations may be adopted.

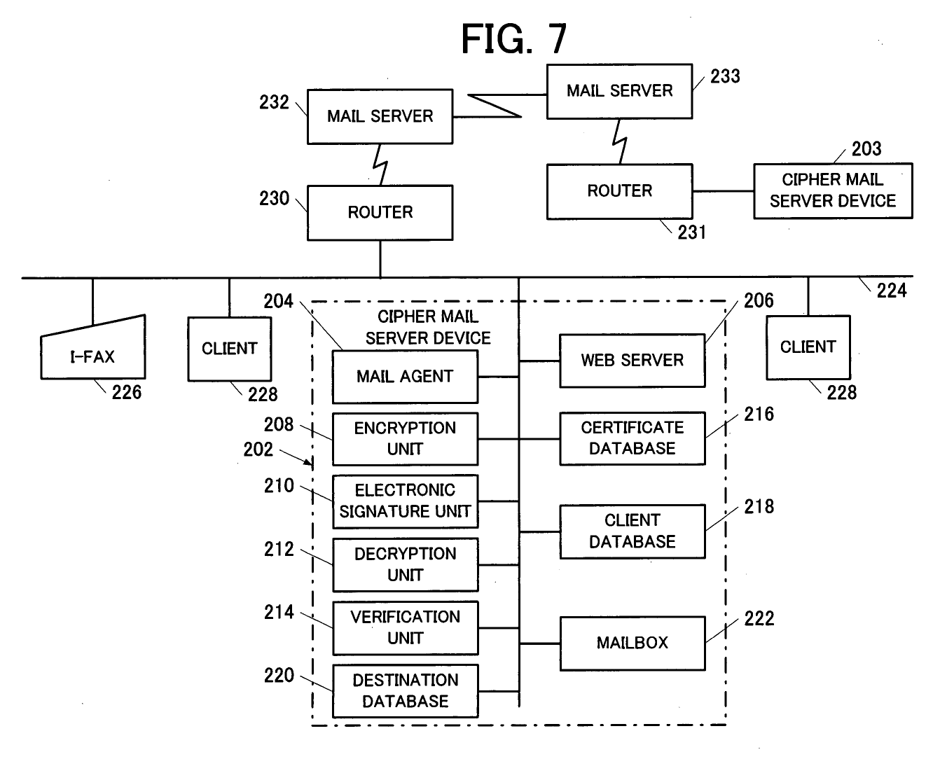

(Second embodiment) FIG. 7 through FIG. 11 illustrate a cipher mail server device 202 according to a second embodiment of the present invention. A mail agent 204 transmits and receives mail by a protocol such as a Simple Mail Transfer Protocol (SMTP), a Post Office Protocol (POP) and an Internet Mail Access Protocol (IMAP). A web server 206 transmits and receives web mail as a Hyper Text Markup Language (HTML) document by a Hyper Text Transfer Protocol (HTTP) or the like to and from, for example, a client 228 on a LAN 224. The web server 206 transmits setting data of the cipher mail server device 202 in a form of a HTML document or the like to a personal computer or the like of a manager of the cipher mail server device 202. The manager can edit the setting data from the personal computer or the like of the manager.

An encryption unit 208 carries out an encryption by a public key encryption or a secret key encryption. The encryption unit 208 already supports major types of an encryption algorithm carried out in transmission and reception of mail. An electronic signature unit 210 adds an electronic signature to transmission mail. The electronic signature unit 210 transmits a certificate of an electronic signature prior to transmission of the mail with the electronic signature. By using a secret key corresponding to a public key written in the certificate, the electronic signature unit 210 calculates a message digest (hash value) for a main text or a main text and an attached file of the mail to be signed. Then, the electronic signature unit 210 adds the message digest processed by the secret key as an electronic signature. When a range of data to be signed is small, for example, when mail includes only a few lines of a main text, the entire main text may be signed by the secret key, and the message digest may not be used.

An electronic signature using a certificate shared by clients in the LAN 224 of the cipher mail server device 202, and an electronic signature using a certificate unique to each client are two types of the electronic signature. The electronic signature by the certificate unique to each client is strong, and the electronic signature shared by the clients of the cipher mail server device 202 is weak. The electronic signature unique to each client may be unique to an individual client or to a group of clients smaller than the entire clients of the cipher mail server device 202.

A client capable of using a plurality of certificates can select any one of electronic signatures for each transmission mail or according to a designation by a default value or an option set appropriately. For example, the client can designate a certificate for each transmission destination. Alternatively, the client can designate a type of a certificate by a keyword such as “important” and “urgent” that appears in a header or a main text of mail, or by a description in a subject field. Alternatively, the client can use a certificate used in previous transmission for next transmission when there is no designation in particular. Further, each client can select whether or not to encrypt mail, whether or not to add an electronic signature, or whether or not to carry out both an encryption and an electronic signature.

When receiving encrypted mail, a decryption unit 212 decrypts the received encrypted mail into a plaintext. When receiving mail with an electronic signature, a verification unit 214 processes the electronic signature by using a public key of a transmitter. For example, the verification unit 214 verifies whether or not the processed electronic signature coincides with a value of a message digest. When the processed electronic signature coincides with the value of the message digest, a confirmation can be made that the transmitter is an owner of the public key and that a part added with the electronic signature has not been falsified during transmission.

A certificate database 216 stores a certificate of an electronic signature shared by clients of the cipher mail server device 202 and a certificate unique to a client. The certificate database 216 manages, for example, a presence or an absence of a lapse of an expiration date and a revocation. The verification unit 214 inspects a presence or an absence of a revocation of a certificate stored in the certificate database 216 from a website of a certificate authority or the like. As a result of an inquiry to the certificate database 216, when an expiration date has lapsed, in case of a presence of a certificate that can be a substitute of such a fact, the certificate database 216 outputs data of a substitute certificate. For example, when an expiration date of a certificate of an individual user has lapsed, data of a shared certificate is output as a substitute certificate.

A client database 218 stores data relating to clients of the cipher mail server device 202. The client database 218 also stores a range of a usable certificate and a standard defining a priority order of certificates. Further, the range of the usable certificate refers to whether or not only a shared certificate can be used, or whether or not a unique certificate can be used other than the shared certificate.

For each transmission destination of mail, a destination database 220 stores a setting of whether or not an encryption is necessary, and a public key for an encryption and a certificate of a public key for an electronic signature of a transmission destination. The destination database 220 also stores an algorithm of a public key for an encryption, and a signature algorithm of a public key for a verification of an electronic signature. For example, the destination database 220 stores a certificate attached to received mail. By periodically browsing a website of a certificate authority or the like, the destination database 220 inspects whether or not the certificate is valid. Moreover, a mailbox 222 stores transmission mail or received mail of each client.

An Internet facsimile machine 226 carries out Internet facsimile communication in a form of mail or the like, other than G3 facsimile communication or the like. The Internet facsimile machine 226 transmits and receives mail by a protocol such as the SMTP, the IMAP and the POP. Further, the cipher mail server device 202 can be provided integrally with the Internet facsimile machine 226 or the like, and the cipher mail server device 202 can be a part of the Internet facsimile machine 226 or the like. A personal computer 228 (in the drawing “PC”) is an example of a client.

The LAN 224 is connected to a remote mail server 232 via a router 230. The Internet facsimile machine 226 and the cipher mail server device 202 operate as a POP client of the remote mail server 232. Alternatively, the Internet facsimile machine 226 and the cipher mail server device 202 transmit and receive mail independently as an SMTP server or the like. The mail server 232 communicates with a mail server 233 at a transmission destination via a Wide Area Network (WAN) such as the Internet, and transmits and receives mail with a cipher mail server device 203 or the like having a same configuration as the cipher mail server device 202 via a router 231.

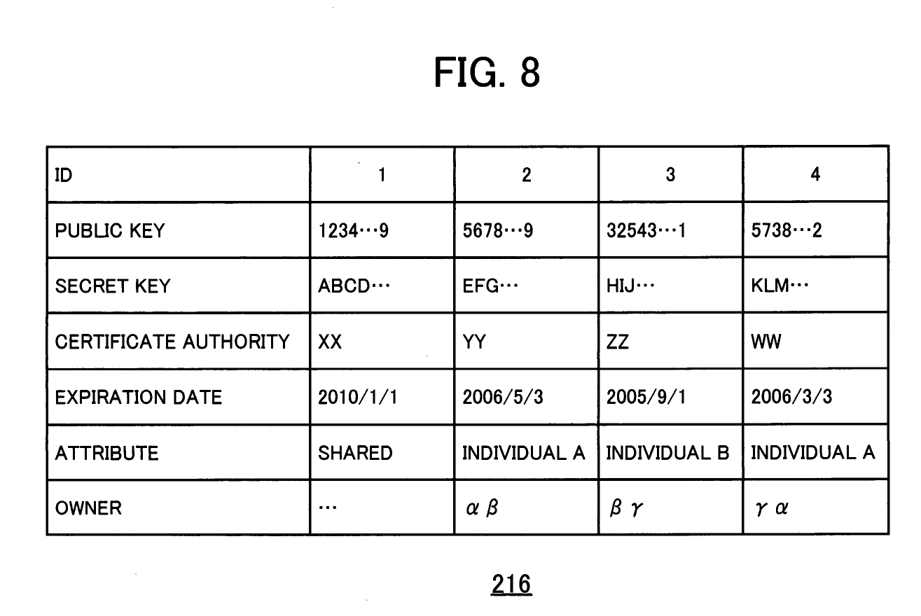

FIG. 8 illustrates an example of the certificate database 216. Each column refers to one certificate. For each certificate, the certification database 216 stores a public key and a secret key corresponding to the public key, a name of a certificate authority that issued the certificate, an expiration date of the certificate, and an algorithm or the like of an electronic signature. For each certificate, the certification database 216 includes information regarding whether the certificate is a certificate shared between clients of the cipher mail server device 202 or a certificate unique to a client. For a unique certificate, strength of the signature is ranked by “A”, “B”, etc. For example, suppose that a total number of clients of the cipher mail server device 202 is one hundred, ten clients among the one hundred clients share a certificate of an ID 2, and only specific clients among the ten clients have a certificate of an ID 3. Then, the certificate of the ID 3 is ranked “B”, which is a rank higher than the rank “A” of the certificate of the ID 2, and the shared certificate of the ID 1 is ranked lowest. That is, when a number of clients sharing a certificate is small, the certificate generally becomes a strong certificate. An owner of a certificate is stored for each certificate. An owner of a shared certificate is all of the clients of the cipher mail server device 202.

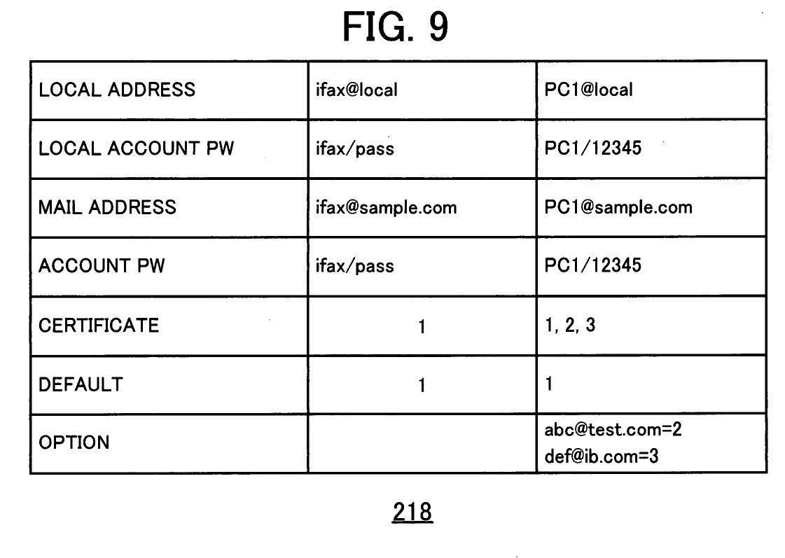

FIG. 9 illustrates an example of the client database 218. For each client, the client database 218 stores a local address, a local account and a local password. The client database 218 also stores a global mail address, a global account and a password for transmission and reception with a remote device provided outside of the LAN. For each client, the client database 218 also stores an ID of a certificate, which can be used for an electronic signature, an encryption or the like. For example, a client in a left column of FIG. 9 can use only a shared certificate, and a client in a right column can use certificates 1, 2 and 3.

When a client can use a plurality of certificates, a default field stores information regarding which certificate to be used in case of an absence of a unique designation. Data having priority over a default value is stored in an option field. For example, a certificate to be used can be defined for each transmission destination or for each appropriate keyword in a header or a main text. Alternatively, a certificate that is the same as the certificate used previously is stored to be used as a default value. Further, each client can select whether or not an electronic signature is necessary when requesting transmission of mail, or whether a type of an electronic signature is an electronic signature for a plaintext (a clear electronic signature) or an electronic signature for an encrypted text. Each client can also designate whether a certificate to be used for an electronic signature is a shared certificate or a unique certificate. This designation has a priority over a type of the certificate decided by the client database 218.

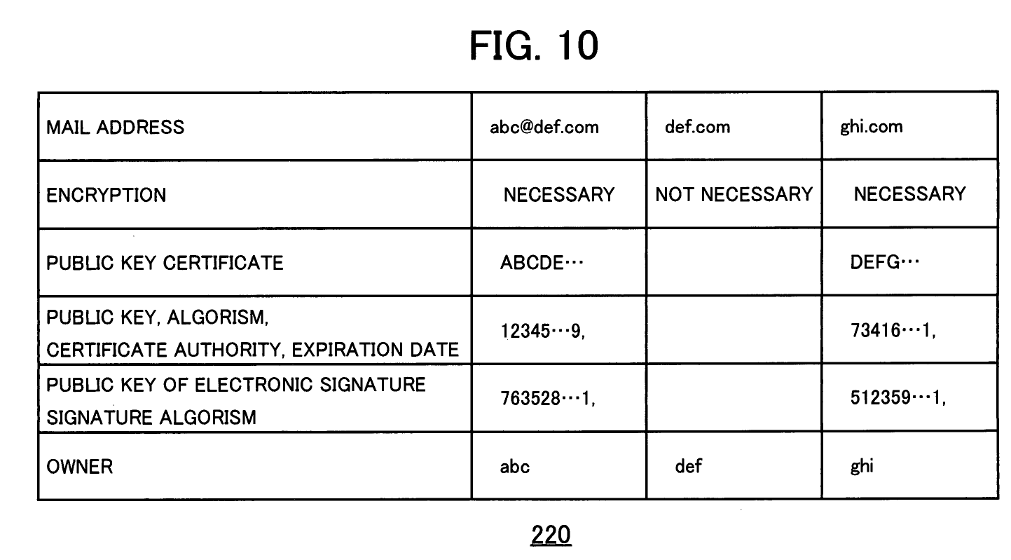

FIG. 10 illustrates an example of the destination database 220. For each mail address of a destination, for example, the destination database 220 stores a default value of whether or not to encrypt transmission mail, a serial number, a public key and an algorithm of a public key certificate of the destination, a certificate authority that issued the certificate, and an expiration date of the certificate. The destination database 220 also stores a public key of an electronic signature of the destination, and an algorithm of a signature. By providing the destination database 220, an electronic signature of received mail can be verified easily, and a public key is not required to be acquired each time before transmitting mail.

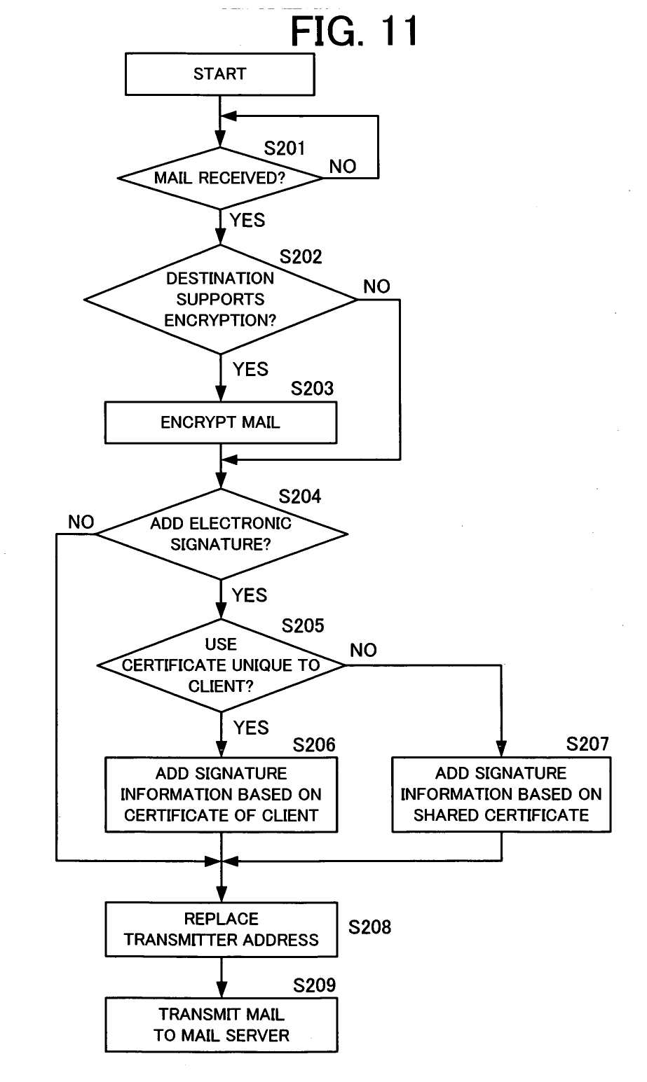

FIG. 11 illustrates an algorithm relating to an encryption and an electronic signature of transmission mail according to the second embodiment of the present invention. When receiving mail from a client such as the Internet facsimile machine 226 (step S201), a determination is carried out as to whether or not the mail is designated to be encrypted, or whether or not a destination of the received mail is designated as a destination requiring an encryption in the destination database 220 (step S202). For example, when the mail is designated to be encrypted by either one or by both of the designations, the received mail is encrypted (step S203). When an encryption is unnecessary, the process of step S203 is bypassed.

Next, the cipher mail server device 202 checks whether or not a necessity of an electronic signature is designated in the mail received from the client (step S204). Further, a default value regarding the necessity of the electronic signature can be described in the destination database 220 or the client database 218. Then, even when there is no designation from a client, an electronic signature can be carried out for a specific destination (transmission destination) or a specific client. When an electronic signature is necessary, the cipher mail server device 202 refers to the client database 218 for a type of a usable certificate, and decides which certificate to be used according to a description in a header of the mail received from the client or according to a transmission destination or the like of the mail received from the client (step S205). Further, when a client can use only a shared certificate, a type of the certificate is one type. When a client can use a plurality of certificates, one of the certificates can be selected. Furthermore, an expiration date of the certificate is inspected in accordance with the certificate database 216. When the expiration date has lapsed, a certificate ranked lower, for example, a shared certificate, is used.

When a certificate unique to a client can be used, an electronic signature is carried out in accordance with the unique certificate (step S206). When using a shared certificate, an electronic signature is carried out in accordance with the shared certificate (step S207). The electronic signature can be carried out on a plaintext or on an encrypted text. Further, in FIG. 11, first, an encryption of the received mail is carried out, and then, an electronic signature is added to the mail. However, an electronic signature can be added first, and then, an encryption can be carried out. Then, a mail address of a transmitter is replaced from a local address of the client to a global address corresponding to the certificate (step S208), and the mail is transmitted to a remote mail server via a router (step S209).

The second embodiment has the following advantages. (1) Even when a client does not have a unique certificate, an electronic signature can be carried out by using a shared certificate. (2) Although an expiration date of a certificate unique to a client is prone to be lapsed, in such a case, an electronic signature can be carried out by using a shared certificate temporarily. (3) When a client can use a plurality of certificates, a setting can be made as to use which certificate.

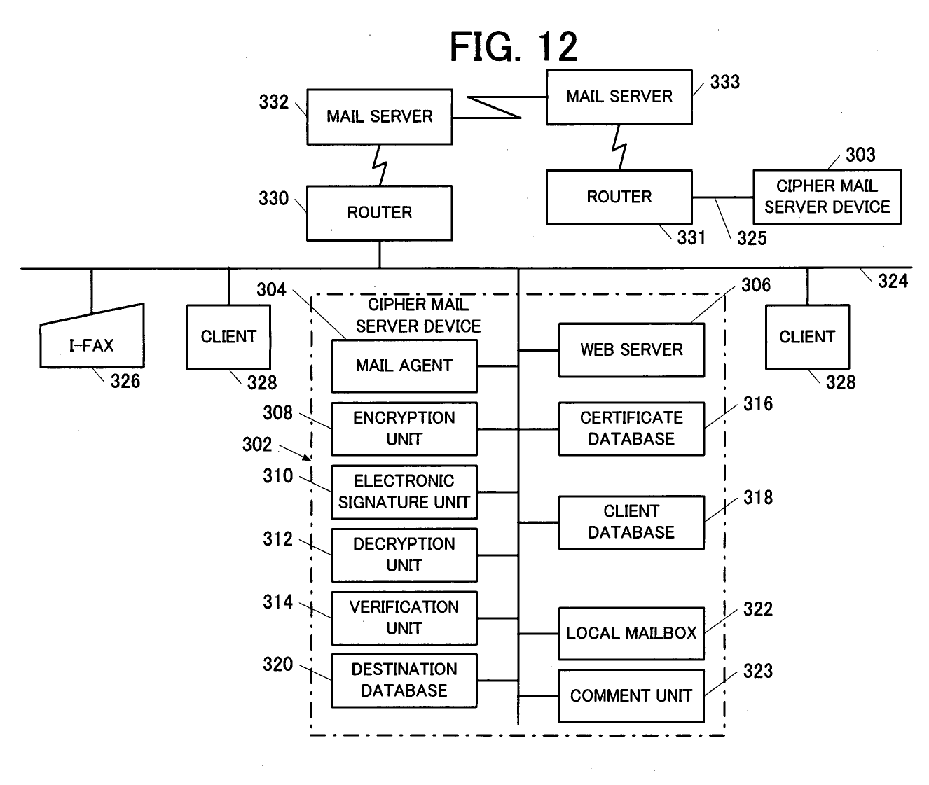

(Third Embodiment) FIG. 12 through FIG. 20 illustrate cipher mail server devices 302 and 303 according to a third embodiment of the present invention, and also a different example of the third embodiment. A mail agent 304 transmits and receives mail inside and outside of LANs 324 and 325 by a protocol such as the SMTP, the POP and the IMAP. A web server 306 transmits and receives web mail in a form of an HTML document by the HTTP or the like to and from, for example, a client 328 within the LAN 324. The web server 306 also transmits setting data of the cipher mail server device 302 in a form of an HTML document or the like to a personal computer or the like of a manager of the cipher mail server device 302. Accordingly, the manager can edit the setting data from the personal computer or the like of the manager. Further, a configuration of the cipher mail server device 302 is the same as a configuration of the cipher mail server device 303. Reference numerals 324 and 325 are used for distinguishing the LAN at a transmitting end and the LAN at a receiving end.

An encryption unit 308 carries out an encryption by a public key encryption or a secret key encryption. The encryption unit 308 already supports major types of an encryption algorithm carried out in transmission and reception of mail. An electronic signature unit 310 adds an electronic signature to transmission mail. The electronic signature unit 310 transmits a certificate of an electronic signature prior to transmission of the mail with the electronic signature. By using a secret key corresponding to a public key written in the certificate, the electronic signature unit 310 calculates a message digest (hash value) for a main text or a main text and an attached file of the mail to be signed. Then, the electronic signature unit 310 adds the message digest processed by the secret key as an electronic signature. When a range of data to be signed is small, for example, when mail includes only a few lines of a main text, the entire main text may be processed by the secret key, and the message digest may not be used.

An electronic signature using a certificate shared by clients in the LAN 324 of the cipher mail server device 302, and an electronic signature using a certificate unique to each client are two types of the electronic signature. The electronic signature by the certificate unique to each client is strong, and the electronic signature shared by the clients of the cipher mail server device 302 is weak. The electronic signature unique to each client may be unique to an individual client or to a group of clients smaller than the entire clients of the cipher mail server device 302.

A client capable of using a plurality of certificates can select any one of electronic signatures for each transmission mail or according to a designation by a default value or an option set appropriately. For example, the client can designate a certificate for each transmission destination. Alternatively, the client can designate a type of a certificate preferentially by a keyword such as “important” and “urgent” that appears in a header or a main text of mail, or by a description in a subject field. Alternatively, the client can use a certificate used in previous transmission for next transmission when there is no designation in particular. Further, each client can select whether or not to encrypt mail, whether or not to add an electronic signature, or whether or not to carry out both an encryption and an electronic signature.

When receiving encrypted mail, a decryption unit 312 decrypts the received encrypted mail into a plaintext. When receiving mail with an electronic signature, a verification unit 314 processes the electronic signature by using a public key of a transmitter. For example, the verification unit 314 verifies whether or not the processed electronic signature coincides with a value of a message digest. When the processed electronic signature coincides with the value of the message digest, a confirmation can be made that the transmitter is an owner of the public key and that a part added with the electronic signature has not been falsified during transmission.

A certificate database 316 stores a certificate of an electronic signature shared by clients of the cipher mail server device 302 and a certificate unique to each client. The certificate database 316 manages, for example, a presence or an absence of a lapse of an expiration date and a revocation. The verification unit 314 inspects a presence or an absence of a revocation of a certificate stored in the certificate database 316 from a website of a certificate authority or the like. As a result of an inquiry to the certificate database 316, when an expiration date has lapsed, in case of a presence of a certificate that can be a substitute of such a fact, the certificate database 316 outputs data of a substitute certificate. For example, when an expiration date of a certificate of an individual user has lapsed, data of a shared certificate is output as a substitute certificate. A client database 318 stores data relating to clients of the cipher mail server device 302. The client database 318 also stores a range of a usable certificate and a standard defining a priority order of certificates. Further, the range of the usable certificate refers to whether or not only a shared certificate can be used, or whether or not a unique certificate can be used other than the shared certificate.

For each transmission destination of mail, a destination database 320 stores a setting of whether or not an encryption is necessary, and a public key for an encryption and a certificate of a public key for an electronic signature of a transmission destination. The destination database 320 also stores an algorithm of a public key for an encryption, and a signature algorithm of a public key for a verification of an electronic signature. For example, the destination database 320 stores a certificate attached to received mail. By periodically browsing a website of a certificate authority or the like, the destination database 320 inspects whether or not the certificate is valid. Moreover, a local mailbox 322 stores transmission mail or received mail of each client.

When receiving encrypted mail and the received mail is decrypted by the decryption unit 312, a comment unit 323 adds a comment indicating a fact that the mail has been received as encrypted mail, and transfers the mail to a client in the LAN 324. When receiving mail with an electronic signature from outside of the LAN 324, the comment unit 323 adds a verification result of the electronic signature as a comment, and transfers to a client in the LAN 324. Further, the verification result includes information specifying a transmitter, such as a name of the transmitter, and a fact that the mail has not been falsified. When failing in the verification of the electronic signature, the comment unit 323 adds a comment indicating a fact that the mail may have been falsified during communication.

An Internet facsimile machine 326 carries out Internet facsimile communication in a form of mail or the like, other than G3 facsimile communication or the like. The Internet facsimile machine 326 transmits and receives mail by a protocol such as the SMTP, the IMAP and the POP. Further, the cipher mail server devices 302 and 303 can be provided integrally with the Internet facsimile machine 326, and the cipher mail server devices 302 and 303 can be a part of the Internet facsimile machine 326. A personal computer 328 (in the drawing “PC”) is an example of a client.

The LAN 324 is connected to a remote mail server 332 via a router 330. The Internet facsimile machine 326 and the cipher mail server devices 302 and 303 operate as a POP client of remote mail servers 332 and 333. Alternatively, the Internet facsimile machine 326 and the cipher mail server devices 302 and 303 transmit and receive mail independently as an SMTP server or the like. The mail server 332 communicates with the mail server 333 at a transmission destination via a WAN such as the Internet, and transmits and receives mail with the cipher mail server device 303 or the like via a router 331 and the LAN 325. A space inside the LANs 324 and 325 provided on a ground is assumed to be a safe environment, not a wireless LAN or the like. The mail is transmitted and received in a form of a plaintext within the LANs 324 and 325 without requiring an electronic signature. The cipher mail server devices 302 and 303 carry out an encryption and an electronic signature when transmitting mail to a remote device located outside of the LANs 324 and 325. The cipher mail server devices 302 and 303 also carry out a decryption and a verification of an electronic signature of mail received from a remote device located outside of the LANs 324 and 325. Therefore, a client is not required to assign a resource for cipher communication and an electronic signature.

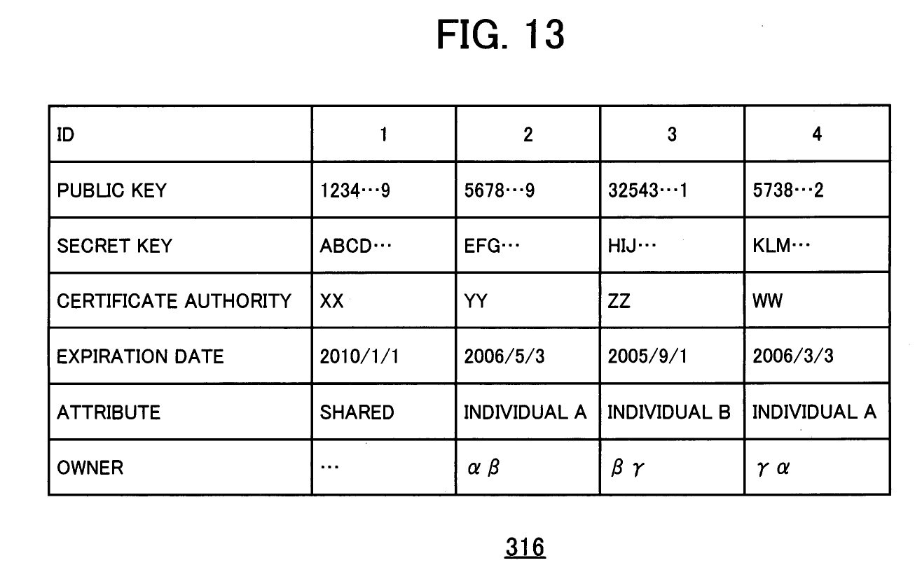

FIG. 13 illustrates an example of the certificate database 316. Each column refers to one certificate. For each certificate, the certification database 316 stores a public key and a secret key corresponding to the public key, a name of a certificate authority that issued the certificate, an expiration date of the certificate, and an algorithm or the like of an electronic signature. For each certificate, the certification database 316 includes information regarding whether the certificate is a certificate shared between clients of the cipher mail server device 302 or a certificate unique to a client. For a unique certificate, strength of the signature is ranked by “A”, “B”, etc. For example, suppose that a total number of clients of the cipher mail server device 302 is one hundred, ten clients among the one hundred clients share a certificate of an ID 2, and only specific clients among the ten clients have a certificate of an ID 3. Then, the certificate of the ID 3 is ranked “B”, which is a rank higher than the rank “A” of the certificate of the ID 2, and the shared certificate of the ID 1 is ranked lowest. That is, when a number of clients sharing a certificate is small, the certificate generally becomes a strong certificate. An owner of a certificate is stored for each certificate. An owner of a shared certificate is all of the clients of the cipher mail server device 302.

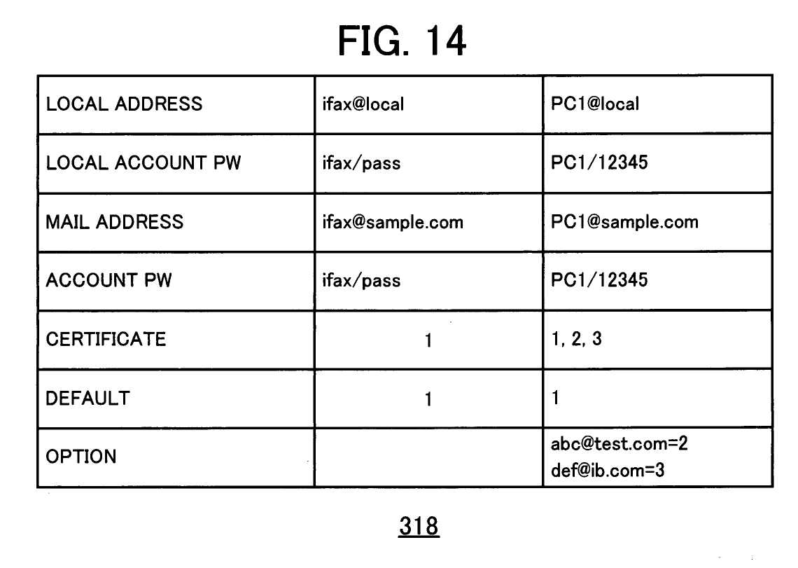

FIG. 14 illustrates an example of the client database 318. For each client, the client database 318 stores a local address, a local account and a local password. The client database 318 also stores a global mail address, a global account and a password for transmission and reception with a remote device provided outside of the LAN. For each client, the client database 318 also stores an ID of a certificate, which can be used for an electronic signature, an encryption or the like. For example, a client in a left column of FIG. 14 can use only a shared certificate, and a client in a right column can use certificates 1, 2 and 3.

When a client can use a plurality of certificates, a default field stores information regarding which certificate to be used in case of an absence of a unique designation. Data having priority over a default value is stored in an option field. For example, a certificate to be used can be defined for each transmission destination or for each appropriate keyword in a header or a main text. Alternatively, a certificate that is the same as the certificate used previously is stored to be used as a default value. Further, each client can select whether or not an electronic signature is necessary when requesting transmission of mail, or whether a type of an electronic signature is an electronic signature for a plaintext (a clear electronic signature) or an electronic signature for an encrypted text. Each client can also designate whether a certificate to be used for an electronic signature is a shared certificate or a unique certificate. This designation has a priority over a type of the certificate decided by the client database 318.

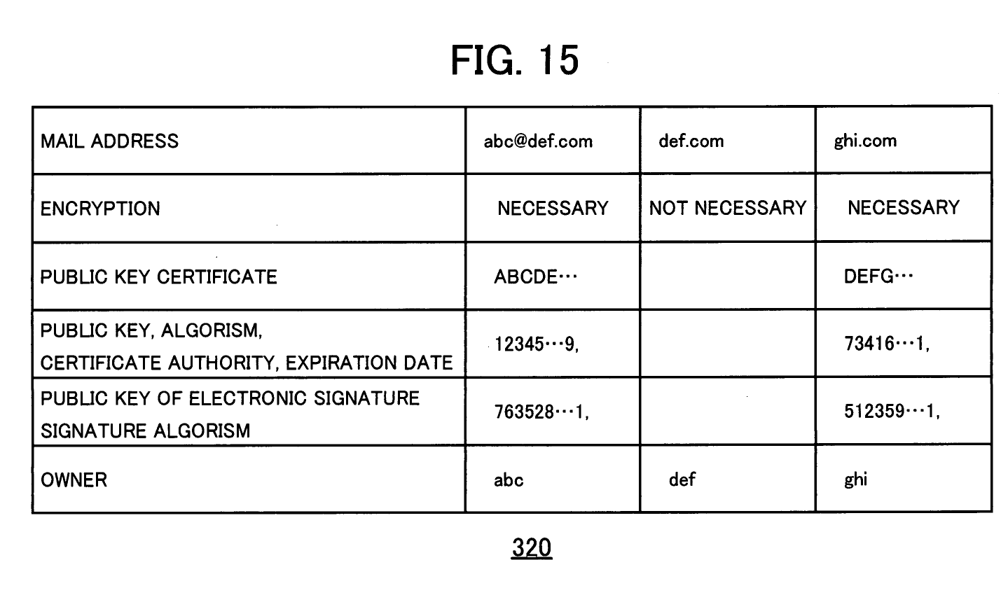

FIG. 15 illustrates an example of the destination database 320. For each mail address of a destination, for example, the destination database 320 stores a default value of whether or not to encrypt transmission mail, a serial number, a public key and an algorithm of a public key certificate of the destination (transmission destination), a certificate authority that issued the certificate, and an expiration date of the certificate. The destination database 320 also stores a public key of an electronic signature of the destination, and an algorithm of a signature. By providing the destination database 320, an electronic signature of received mail can be verified easily, and a public key is not required to be acquired each time before transmitting mail.

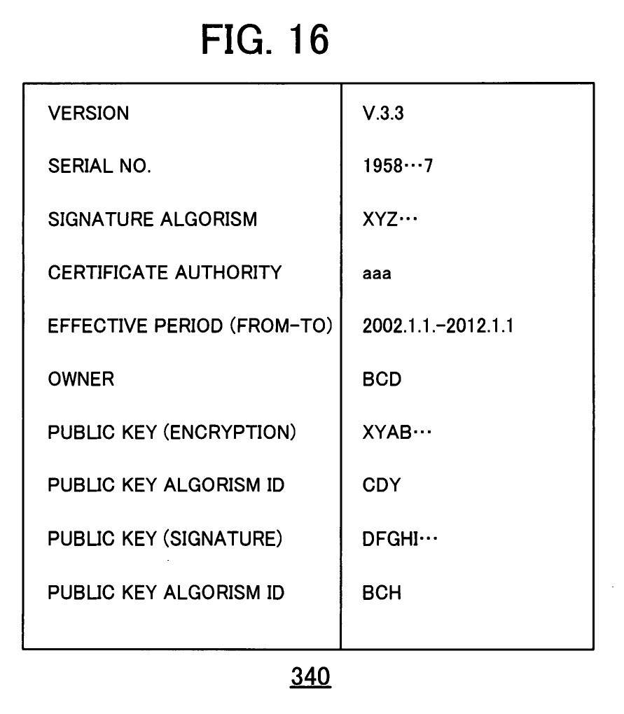

FIG. 16 illustrates an example of a certificate 340 of a public key for an encryption or an electronic signature. For example, the certificate 340 includes a version of the certificate, a serial number of the certificate, and an algorithm or the like to be used for a signature. The certificate 340 also includes a name of a certificate authority that issued the certificate, and a starting date and a last date of an effective period of the certificate. The certificate 340 also includes information of an owner of the certificate, that is, information of a person or a client using a public key of an encryption or an electronic signature described in the certificate. For both of the encryption and the electronic signature, the certificate 340 includes a public key and an algorithm.

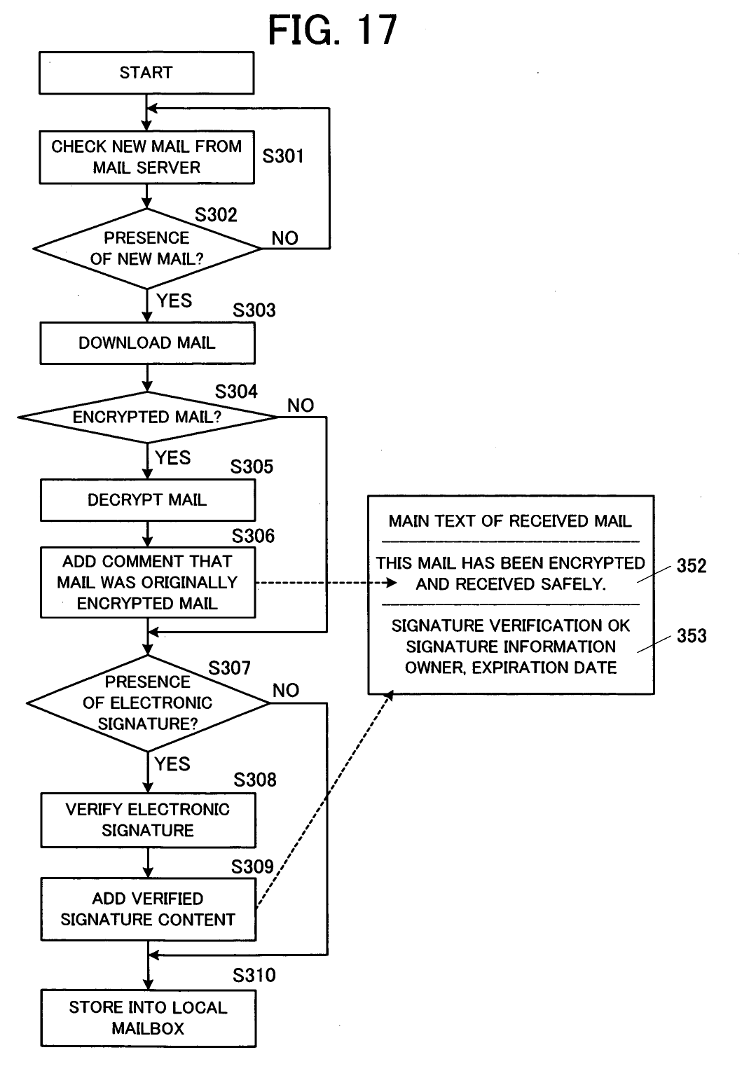

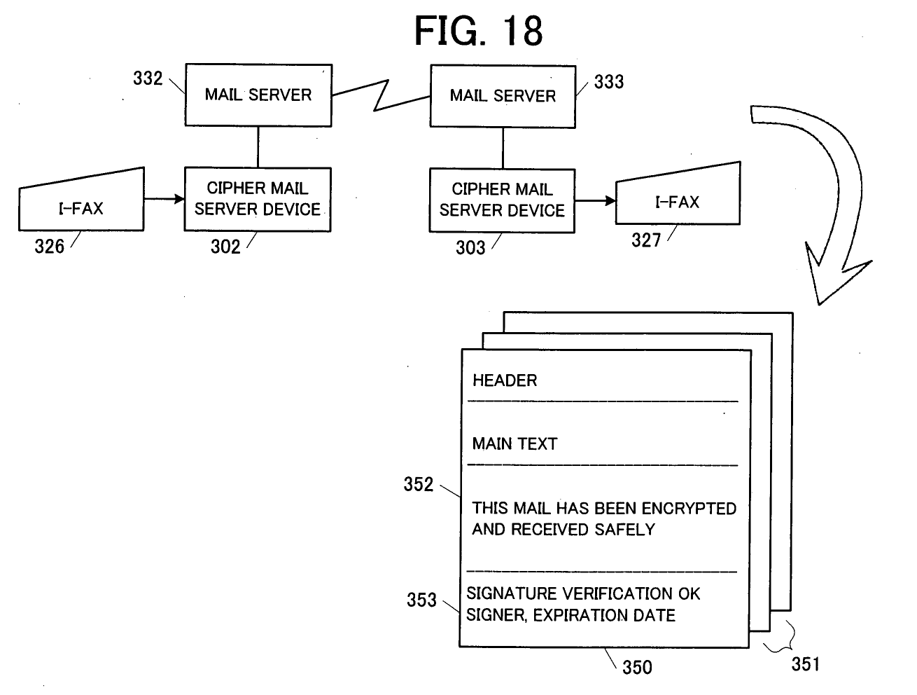

FIG. 17 and FIG. 18 illustrate a processing when adding a fact that the received mail is encrypted mail or a verification result of an electronic signature, as a comment. As illustrated in FIG. 18, suppose that a client such as the Internet facsimile machine 326 transmits encrypted mail or mail with an electronic signature via a mail server at a transmitting end, such as the cipher mail server device 302, to the cipher mail server device 303 at a receiving end. The cipher mail server device 303 carries out a decryption or a verification of an electronic signature, and adds corresponding comments 352 and 353 to a header or a main text of the mail. Then, the cipher mail server device 303 transfers the comments 352 and 353 in a form of a plaintext to the Internet facsimile machine 327 or the like of a client.

In the algorithm of FIG. 17, the cipher mail server device 303 at the receiving end checks a presence or an absence of new mail from a mail server located outside of the LAN (step S301). In case of a presence of new mail (step S302: YES), the cipher mail server device 303 downloads the mail (step S303). When the mail is encrypted mail (step S304: YES), the mail is decrypted at step S305. Then, at step S306, the cipher mail server device 303 adds the comment 352, such as “This mail has been encrypted and received safely (in communication)”. When receiving the mail in a form of a plaintext, the processes of steps S305 and S306 are bypassed.

A presence or an absence of an electronic signature is inspected at step S307. In case of a presence of an electronic signature (step S307: YES), the electronic signature is verified at step S308. When a verification result is “OK”, for example, “signature verification OK; signer XUZ; effective period of signature; mail has been received as transmitted by the signer, without being falsified” is added as the comment 353. When failing in the verification, a fact that the mail may have been falsified in a communication path is added as a comment for a warning. In case of an absence of an electronic signature, the processes of steps S308 and S309 are bypassed. Further, when an electronic signature is added to an encrypted text, the processes of step S307 through step S309 are executed before the processes of step S304 through step S306. Then, the decrypted and verified mail is stored into a local mailbox (step S310).

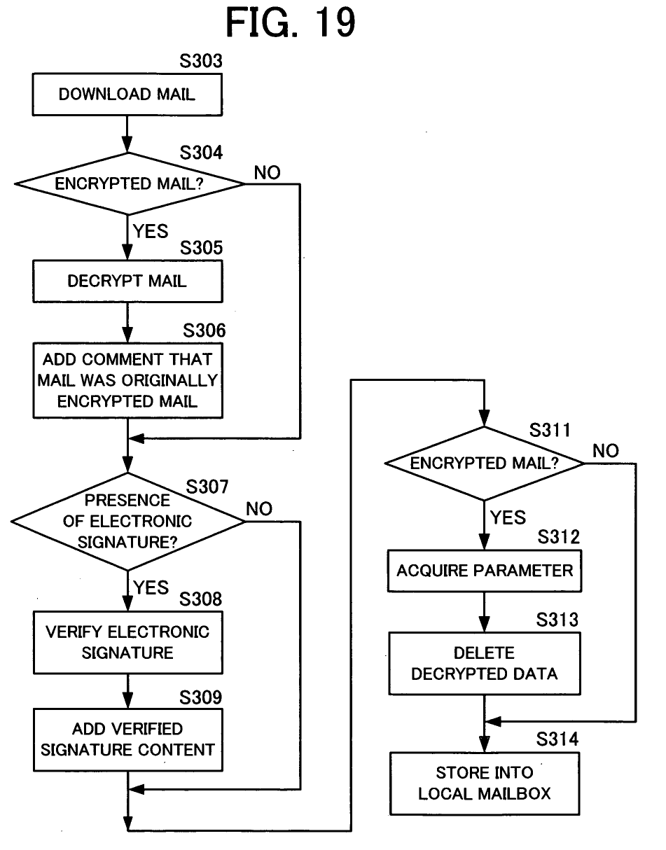

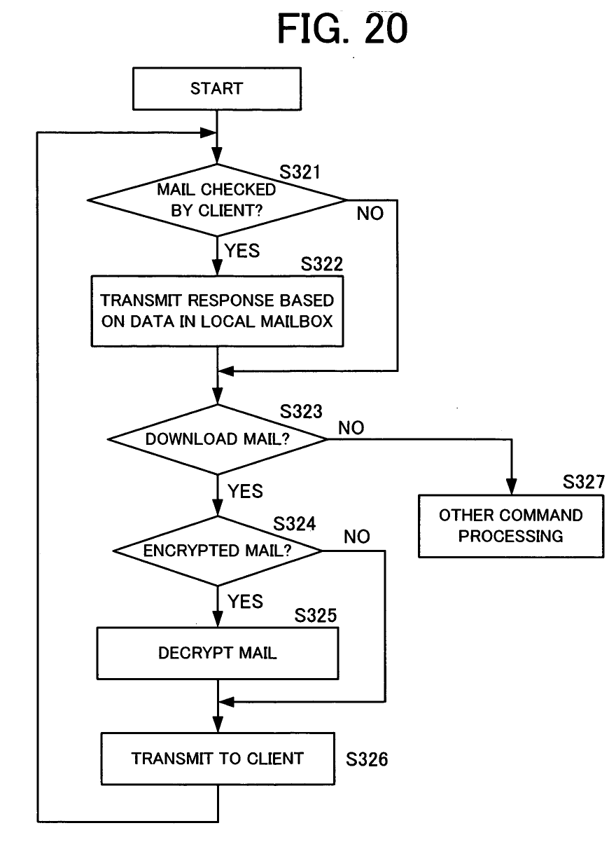

FIG. 19 and FIG. 20 illustrate an algorithm added with a countermeasure against an unauthorized access made to the cipher mail server devices 302 and 303 from outside of the LAN. This algorithm is the same as the algorithm of FIG. 17 (step S301 through step S309) up to an addition of the verification result of the electronic signature as a comment at step S309. However, the decryption of step S305 is carried out for acquiring a parameter. Therefore, for example, only the main text may be decrypted and an attached file may not be decrypted. Moreover, in general, the header is transmitted without being encrypted.

To eliminate necessity of storing decrypted mail in a local mailbox, an inspection is carried out at step S311 as to whether or not the mail is encrypted mail. When the mail is encrypted mail, a parameter is acquired at step S312. For example, the parameter is a comment such as a fact that the mail has been transmitted in a form of an encrypted text, a signer of the electronic signature, and a fact that the mail was not falsified during communication. The parameter is also a presence or an absence of an attached file, data length of the attached file, a transmission date or other keyword. The decrypted data is deleted at step S313. Then, the encrypted mail and the parameter are stored into a local mailbox (step S314). As a result, even when an unauthorized access is made to the local mailbox, the access is prevented from being made to a plaintext of the mail.

Next, in the algorithm of FIG. 20, an inspection is carried out at step S321 as to whether or not mail is being checked from a client. When the mail is being checked, a response is made in accordance with data stored in the local mailbox (step S322). That is, when mail in a form of plaintext is stored in the local mailbox, a response made in accordance with the plain text. When the encrypted text is stored, a response is made in accordance with a part that is not encrypted, for example, a header of the encrypted text or the parameter. Accordingly, the client can confirm a length of the mail, a presence or an absence of an attached file, a transmission date, a presence or an absence of an encryption, a presence or an absence of an electronic signature, a verification result of the electronic signature, and a transmitter of the mail or the like.

At step S323, a determination is carried out as to whether or not to download the mail. When downloading the mail, in case of encrypted mail (step S324), the mail is decrypted and transmitted to a client (step S325 and step S326). In case of plaintext mail, the mail can be transferred directly to the client (step S326). In case of a command other than a command for downloading the mail, a processing is carried out according to the command requested by the client (step S327).

The third embodiment has the following advantages. (1) Since a cipher mail server device can carry out an encryption, a decryption, an electronic signature and a verification of the electronic signature, a client is not required to be provided with such functions. (2) When a plurality of certificates can be used for an electronic signature to be added to transmission mail, a client can select a certificate to be used from the plurality of the certificates. (3) A risk resulting from decrypting encrypted mail and storing as a plaintext in a local mailbox can be reduced.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. A cipher mail server device, comprising:
a receiving unit arranged to receive mail;
a management table arranged to store mail processing information indicating a processing content of the mail for each account by associating with each account;
a determination unit arranged to access the management table when the receiving unit receives the mail, acquire the mail processing information associated with an account of the mail, and determine a processing content for the mail;
a processing unit arranged to execute the processing content determined by the determination unit on the mail; and
means for transferring the mail executed with the processing content.

2. The cipher mail server device according to claim 1, wherein the mail includes encrypted mail;
the management table stores decryption information indicating whether or not to decrypt the encrypted mail for each account by associating with each account;
the determination unit accesses the management table when the receiving unit receives the encrypted mail, acquires the decryption information associated with an account of the encrypted mail, and determines whether or not to decrypt the encrypted mail; and the processing unit includes a decryption unit arranged to decrypt the encrypted mail determined by the determination unit to be decrypted.

3. The cipher mail server device according to claim 1, wherein the mail includes mail with an electronic signature;
the management table stores verification information indicating whether or not to verify the electronic signature of the mail with the electronic signature for each account by associating with each account;
the determination unit accesses the management table when the receiving unit receives the mail with the electronic signature, acquires the verification information associated with an account of the mail with the electronic signature, and determines whether or not to verify the electronic signature of the mail with the electronic signature; and
the processing unit includes a verification unit arranged to verify the mail with the electronic signature when the determination unit determines to verify the mail with the electronic signature.

4. The cipher mail server device according to claim 1, further comprising:
an accepting unit arranged to accept a changing instruction of the management table; and
a changing unit arranged to change the management table in accordance with the changing instruction accepted by the accepting unit.

5. The cipher mail server device according to claim 4, further comprising a mail storage unit arranged to store the mail received by the receiving unit;
wherein the management table stores changing information for each account by associating with each account, the changing information indicates whether or not the execute the processing content when accepting the changing instruction on the mail stored in the mail storage unit;
the determination unit accesses the management table when the accepting unit accepts the changing instruction, acquires the changing information associated with an account that accepted the changing instruction, and determines whether or not to execute the processing content on the mail stored in the mail storage unit; and
when the determination unit determines to execute the processing content on the mail stored in the mail storage unit, the processing unit executes the processing content on the mail of the account.

6. The cipher mail server device according to claim 1, further comprising a recording unit arranged to record a result of the processing content of the processing unit.

7. The cipher mail server device according to claim 6, wherein the recording unit includes an inserting unit arranged to insert the result into the mail received by the receiving unit.

8. The cipher mail server device according to claim 6, further comprising a history storage unit arranged to store a history of the result recorded by the recording unit.

9. The cipher mail server device according to claim 1, wherein the account is a transmitter address of the received mail.

10. The cipher mail server device according to claim 1, wherein the account is a destination address of the received mail.

11. A cipher mail server device, comprising:
means for receiving mail;
means for adding an electronic signature to the mail;
means for storing a certificate shared by a plurality of clients and a certificate unique to a client; and
means for controlling to add an electronic signature based on one of the certificate shared by the plurality of the clients and the certificate unique to the client.

12. The cipher mail server device according to claim 11, wherein when the mail received from the client does not have the certificate unique to the client, the means for controlling adds the electronic signature based on the shared certificate stored in the means for storing.

13. The cipher mail server device according to claim 11, further comprising means for inspecting whether or not the shared certificate and the unique certificate stored in the means for storing are valid;
wherein when the certificate unique to the client received from the client is invalid and the shared certificate is valid, the means for controlling adds the electronic signature based on the shared certificate stored in the means for storing.

14. The cipher mail server device according to claim 11, wherein the client having the certificate unique to the client can select whether to use the shared certificate or to use the certificate unique to the client.

15. A cipher mail server device, comprising:
means for receiving mail;
means for decrypting the mail when the mail received from another mail server is encrypted mail;
means for adding to the decrypted mail, a comment indicating that the received mail was encrypted; and
means for transferring the mail added with the comment to a client.

16. The cipher mail server device according to claim 15, further comprising means for verifying an electronic signature when the mail is signed by the electronic signature;
wherein the means for adding adds a verification result of the means for verifying.

17. The cipher mail server device according to claim 15, further comprising means for storing the received mail;
wherein immediately before the means for transferring transfers the mail, the means for decrypting decrypts the mail and the means for adding adds the comment to the mail.
